(19) United States
(12) Patent Application Publication
(10) Pub. No.: US 2015/0132464 A1
(43) Pub. Date: May 14, 2015

(54) Special Blended Compositions containing corn flour and potato flakes

(71) Applicant: MARTIN UCHE EGBE, LOS ANGELES, CA (US)

(72) Inventor: MARTIN UCHE EGBE, LOS ANGELES, CA (US)

(21) Appl. No.: 14/076,447

(22) Filed: Nov. 11, 2013

(51) Int. Cl. A23L 1/10

(52) U.S. Cl. CPC A23L 1/1041
USPC 426/555

(57) ABSTRACT

This invention is a blended composition of 76-80% Corn flour and 20-24% Potato flakes; for the preparation of FUFU a popular Africa meal, and for making Infant and Children food formula.

### BACKGROUND OF THE INVENTION

The inspiration for this invention stems from the need to find a healthy alternative choice for the making of “FUFU” a staple food eaten by most people in Africa. FUFU has traditionally been made out of so many plant produce including grains and tubers. From grains like maize, millet, wheat, rice, oat, etc., to tubers like cassava, yam, cocoyam etc.; the of blending corn flour and potato flakes for use in making FUFU is as a result of my endeavor to find a cheaper and healthy alternative for the making of FUFU. Over the years, advancements have been made in the production and preservation of Corn and Potato, thereby driving down the overall price of both crops. Corn has been a dietary staple for thousands of years in Mesoamerica. The fiber-rich food property of corn provides steady, slow-burning source energy. It has the benefit of stabilizing blood sugar, lowering cholesterol, and even helps in the prevention of colon cancer. Corn as an ancient agricultural life source has remained an essential part of a modern balanced diet. This is due to advancements in the cultivation, storage and processing of this all important food crop. Potato is the world's fourth largest food crop, behind rice, wheat, and maize. It was first cultivated by Inca Indians in Peru around 8,000 BC to 5,000 B.C. Over the years, agriculturalists have found potatoes easier to grow and cultivate than other staple crops, such as wheat and oats. Most importantly, it became known that potatoes contained most of the vitamins needed for sustenance.

The ultimate objective of this invention is to help curb hunger in Africa, by way of encouraging local production of the basic raw materials i.e. Corn and Potato, in other to reduce chronic poverty, in hunger stricken African nations.

### SUMMARY OF THE INVENTION

This invention of a Blended compositions of 76-80% Corn flour and 20-24% Potato flakes is an alternative ingredient for making the FUFU. And when fortified with protein extracts, vitamins and minerals can be used to make nutritious instant food formula for infants and children. This invention is aimed at increasing the production of two food sources in Africa, Corn and Potato, to help reduce world hunger. FUFU made from our Blended composition can be prepared in less than five minutes, as follows:

### COOKING INSTRUCTIONS

A. (Traditional African FUFU)
1. Add 1 Cup or 1½ Cups of water to cooking pot.
2. Bring to boiling point and remove heat source.
3. Add 1 Cup of Blended-Mix to boiling water .
4. Stir with a spatula until mixture is consistent.
5. Return to Heat while stirring for 1 to 2 minutes.

### BEST SERVED WARM

B. (Fortified instant infant and children formula)
1. Add 1 Cup of water to cooking pot.
2. Bring to boiling point and remove heat source.
3. Mix-in ¼ Cup of fortified Blended-Mix in ¼ Cup of cold water.
4. Transfer the mixture above to the boiling water and continue mixing.
5. Stirring-in milk until a smooth pasty consistency.
6. Add sugar to taste (optional)
6. Serve warm or cold as desired.

As unhealthy eating habits become increasingly widespread, the healthy benefits of corn and potato cannot be over emphasized, making our Blended composition of 76-80% Corn flour and 20-24% Potato flakes an industry-leading, healthy choice.

The invention claimed is:

1. A blended composition containing Corn flour and Potato flakes comprising: (i) 20-24% by weight of Potato flakes; and, (ii) 76-80% by weight of Corn flour.

2. The composition of claim 1 is used to prepare FUFU, a traditional African meal.

3. The resulting composition of claim 1 is also used in preparing infants and children food formula.
